(19) United States
(12) Patent Application Publication
(10) Pub. No.: US 2014/0214213 A1
(43) Pub. Date: Jul. 31, 2014

(54) UTILITY CONTROL OF HVAC WITH INTEGRAL ELECTRICAL STORAGE UNIT

(71) Applicant: ROCKY RESEARCH, Boulder City, NV (US)

(72) Inventors: Uwe Rockenfeller, Boulder City, NV (US); Kaveh Khalili, Boulder City, NV (US)

(73) Assignee: ROCKY RESEARCH, Boulder City, NV (US)

(21) Appl. No.: 13/752,785

(22) Filed: Jan. 29, 2013

(51) Int. Cl. G05D 23/19

(52) U.S. Cl. CPC G05D 23/19
USPC 700/276

(57) ABSTRACT

One aspect is an HVAC grid controller that may communicate with local HVAC controllers, wherein the local HVAC controllers control the operation of local HVAC components including an integral electrical storage unit. Thus, the HVAC grid may sends appropriate control signals to local HVAC controllers to, for example, draw power from an electrical storage unit to operate local HVAC components. The local HVAC controller may also be additionally programmable by a user to select a period of time in which the HVAC unit is to be powered by a local electrical storage unit. By using an electrical storage unit to power HVAC components, a utility power provider may better manage load on its electrical grid, and a consumer may avoid peak time-of-use electricity charges.

### BACKGROUND OF THE INVENTION

Utility power providers, such as local and regional power companies, must manage the production and distribution of electric power across large geographic areas and to a variety of different types of power consumers, including: manufacturing, commercial, residential, government, and others. This network of power production and distribution is often referred to as the “power grid” or “electric grid,” and the amount of power being consumed via the grid is often referred to as the “load on the grid” or simply the “load.” One of the most significant consumers of electricity on a power grid is Heating, Ventilation and Air Conditioning (“HVAC”) systems.

HVAC systems maintain the environment of many different types of enclosures, including: houses, buildings, portable enclosures and others, and such systems can require abundant power to operate normally. By design, most HVAC systems cycle on and off frequently during normal operation to maintain a designated temperature within an enclosure. When an HVAC system cycles on, it creates a significant transient load spike on the electrical grid it is attached to, which is often significantly higher than its load during normal operation. This cycling is particularly problematic for utility power providers because they must provide ample capacity to address the normal operating load on the grid as well as excess power to cover transient spikes created by, for example, many HVAC systems cycling on concurrently. Moreover, it is impractical to rapidly vary the output of a utility power provider's power generation units, such as a nuclear power plant or other baseline power generation system, to meet the ever changing demand on the power grid. Additionally, it can be very inefficient to produce excess power to cover all transient load spikes that may be encountered during any particular time period. As such, during periods of peak power usage, such as during business hours in the summer in hot climates, electric load on the grid can overwhelm the instant capacity of the utility power provider causing “brownouts” and even “blackouts.” These situations are very detrimental for power providers as well as power consumers.

In an attempt to mitigate these problems, some utility power providers price electricity based on time-of-use. For example, during “peak” times, electricity may be significantly more expensive to a consumer as compared to electricity consumed during “off-peak” times. This price differentiation is designed to dissuade power consumers from using power during peak times when the electric grid is at or near its capacity and is less resilient to transient load spikes. However, from the perspective of the utility power provider, these systems are only successful if consumers actually respond to the price differentiation by changing their electric use profiles predictably. Often this is not the case, and even when a consumer subscribes to such a program, there is nothing preventing that consumer from choosing to draw power in ways that may lead to the same set of problems initially faced by utility power providers.

Other utility power providers have begun to implement programs whereby utility-connected HVAC control units, such as programmable thermostats, are installed in residential and commercial enclosures. A utility-connected HVAC control unit allows the utility power provider to cycle off an HVAC unit during certain times of the day, typically peak power times, to manage electric load on the grid and to avoid large transient load spikes. Typically the HVAC unit is cycled off by the utility power provider for a period of time ranging from 10 to 30 minutes. While these utility-connected HVAC control units may allow the utility power provider to reduce loads on the grid, they can also greatly inconvenience those residential and commercial customers that need HVAC systems running to be comfortable. In addition, these systems provide residential or commercial customers only limited control of their own HVAC systems during times of peak loads on the system because the utility power provider is controlling their system.

### SUMMARY OF THE INVENTION

Embodiments of the present invention include an HVAC grid controller that may communicate with local HVAC controllers, wherein the local HVAC controllers control the operation of local HVAC components including an integral electrical storage unit. In one embodiment, an HVAC grid controller can control local HVAC controllers via appropriate control signals. For example, as cooling needs rise during a hot summer day, and load on the electric grid increases, an HVAC grid controller may instruct local HVAC controllers to direct their HVAC components to draw power from local electrical storage units, such as batteries, to power, either in-part or in-whole, the local HVAC components so as to reduce the load on the grid. Thereafter, as cooling needs decrease in the evening, or during off peak periods, the HVAC grid controller may instruct local HVAC controllers to direct their HVAC components to draw power from the grid again, and possibly recharge depleted batteries according to embodiments of the systems described herein, such that the utility power provider need not drastically reduce its power output to match the falling electrical demand. Thus, by using stored power capacity in local electrical storage units, the utility power provider may smooth the load on the electric grid and run its generators more efficiently while concurrently reducing transient load spikes.

Furthermore, by using stored power from a local electrical storage unit during peak load times, a consumer can avoid higher time-of-use based electric costs. In a related embodiment, the local HVAC controller is additionally programmable by a user to select a period of time in which the HVAC unit is to be powered by a local electrical storage unit. For example, a power consumer may program the local HVAC controller to draw power from the local electrical storage unit during all peak times to avoid buying higher priced power from the utility power provider.

One embodiment is a control system for managing remote HVAC systems that are part of a control grid. This embodiment includes a local HVAC controller electrically linked to a local HVAC system; a HVAC grid controller operative to send the local HVAC controller a control signal to manage the operation of the HVAC system; and a local electrical storage unit configured to provide power to the local HVAC system when instructed by either the local HVAC controller or the HVAC grid controller.

Another embodiment is a method of controlling a local HVAC unit connected to a control grid that includes receiving a control instruction from a HVAC grid controller configured to control power usage of a local HVAC system; determining if the control instruction conflicts with any pre-stored instructions for the local HVAC system; and changing power input from a main electrical source to a local energy storage based on the received data signal if the control instruction does not conflict with the pre-stored instructions.

Still another embodiment is a method of using a local HVAC controller. This method includes receiving a command at a local HVAC controller to store power from a main power source to a local electrical storage unit connected to a local HVAC system; and sending a control signal to begin charging the local electrical storage unit with power from the main power source.

### BRIEF DESCRIPTION OF THE DRAWINGS

FIG. 1 is a schematic block diagram illustrating an embodiment of an electronic grid with utility control of local HVAC.

FIG. 2 is a schematic block diagram illustrating an embodiment of a condenser unit.

FIG. 3 is a schematic block diagram illustrating an embodiment of an air handling unit.

FIG. 4 is a schematic block diagram illustrating an embodiment of a local HVAC controller.

FIG. 5 is a process flow diagram showing an embodiment of a process for utility control of an HVAC system using an HVAC grid controller and a local HVAC controller.

FIG. 6 is a process flow diagram showing an embodiment of a process for a user to store grid power during off-peak hours for use during peak hours using a local HVAC controller.

FIG. 7 is a process flow diagram showing an embodiment of a process for storing grid power during off-peak hours for use during peak hours using a local HVAC controller.

FIG. 8 is a process flow diagram showing an embodiment of a process for sending an instruction to a local HVAC controller using an HVAC grid controller.

FIG. 9 is a schematic block diagram illustrating an HVAC system according to one embodiment.

FIG. 10 is a schematic diagram illustrating one embodiment of a phase change circuit.

FIG. 11 is a schematic diagram illustrating an embodiment of an HVAC system with a phase change module.

### DETAILED DESCRIPTION

Embodiments relate to a power management system that allows a utility company to efficiently manage power usage on a grid by controlling HVAC units at remote sites, such as residential and commercial sites. In one embodiment the HVAC units include integral or connected batteries. The utility company can use the power management system to control whether one or more HVAC units attached to the grid run on grid-generated power, or on power from the attached batteries.

For example, a utility company HVAC grid controller unit may be configured to communicate with a local HVAC control unit at a residential or commercial site. As cooling needs rise during a hot summer day, and load on the electric grid increases, the utility company HVAC grid controller may instruct the local HVAC controllers in a specific geographic region to draw power for their HVAC units from local batteries to power HVAC components to reduce the load on the power grid. For example, if each local HVAC system included a battery pack that could support HVAC operations for four hours, the utility company control unit may instruct these local HVAC systems to operate for 3.5 hours on battery power to reduce peak power usages on the power grid.

Thereafter, as cooling needs decrease into the evening, the HVAC grid controller may instruct local HVAC controllers to switch their power input requirements back to the power grid again, such that the utility power provider need not drastically reduce its power output to match the falling electrical demand. At the same time, the local HVAC control unit could instruct the attached HVAC system to start recharging the batteries during an off-peak time when the grid power more easily available from the utility company.

By having control over how and when to use the stored power capacity of local batteries attached to the HVAC systems, the utility company may smooth the load on the electric grid and run its generators more efficiently, while concurrently reducing transient load spikes. Additionally, the utility company can control how and when to recharge the local batteries connected to the HVAC systems to efficiently shift some power generation requirements from peak times to off-peak times. A utility company that has control over thousands, tens of thousands, or hundreds of thousands of attached HVAC systems having local power sources, such as batteries, can thereby more efficiently balance its power generation requirements by using the locally attached batteries to supplement and manage the power requirements of its users.

In another embodiment, the local HVAC control unit may allow the consumer to control certain power consumption aspects of its HVAC unit. For example, a consumer may set the HVAC unit using a local HVAC controller to always operate on battery power during peak times (e.g. 2 PM to 4 PM), and then to recharge its connected batteries after midnight when power is less expensive. Thus, by using stored power from local batteries during peak times, the consumer can avoid higher time-of-use based electric costs. In one embodiment the utility company may be able to override a consumer's control choices, so that the utility company may set the consumer's HVAC system to operate on battery power, even when the consumer had specifically selected to operate on grid power. In another embodiment, the consumer's commands could override the utility company's commands.

In one embodiment, the utility company can receive charge information for each battery back connected to a consumer's HVAC system. Thus, in one example, during a peak time, the utility company could instruct each HVAC system within a specific region to use battery power so long as the unit had at least a predetermined amount of battery power available. Thus, HVAC systems with, for example, at least 80% of a full charge would be instructed to use battery power, while those systems with less than 80% of a full charge would stay connected to the power grid. Alternatively, the utility company could instruct each HVAC system within a specific region to use battery power so long as the unit remained above a threshold of power storage. For example, HVAC systems would be instructed to run off of locally attached batteries until those batteries drained to 20% storage capacity.

In a related embodiment, the local HVAC controller may be additionally programmable by a user to select a period of time in which the HVAC unit receives its power from a local electrical storage unit. For example, a power consumer may program the local HVAC controller to draw power from the local electrical storage unit during all peak times to avoid buying higher priced power from the utility power provider.

HVAC units may consist of several components working together to produce conditioned air for enclosures, such as residential (e.g. homes), commercial (e.g. factories), and remote locations. For example, a typical residential HVAC unit includes a compressor, a condenser unit, an evaporator, an evaporator fan or blower, refrigerant piping and ducting. In some embodiments these components may be combined into functional units, such as a condenser unit that includes a compressor motor, a condenser coil, a condenser fan and appropriate control electronics. Also, an air handling unit may include an evaporator, evaporator fan, ducting and appropriate control electronics.

To cool a residential enclosure using a residential HVAC unit, the compressor pumps refrigerant, usually in a gaseous state, up to a high pressure and temperature. Notably, the process of compressing the refrigerant consumes large amount of electricity and is primary constituent of HVAC systems' power draw. The high pressure and temperature refrigerant then enters a condenser unit, such as a condenser coil, which is usually located outside of the residence where it exchanges heat with the outside environment. Often the condenser unit will include a fan to promote heat exchange with the outside environment by driving more air over and through the condenser coil. As the refrigerant cools in the condenser unit, it condenses into a liquid state. The liquefied refrigerant then flows to the evaporator unit where a device, such as a valve, may mitigate the flow of liquid refrigerant into the evaporator unit. As the refrigerant evaporates in the evaporator unit, such as an evaporator coil, it absorbs heat from the air passing over and through the evaporator unit. The cool air is then routed throughout the enclosure via ducting. An evaporator fan or blower is commonly used to force the air through the evaporator coil and through the ducting so as to condition the entire enclosure's air. Finally, the evaporated and gaseous refrigerant returns to the compressor, and the cycle repeats. Notably, this process may be reversed to create a heating effect. Other embodiments of HVAC units may include heat pumps, additional heat exchangers, electric heating coils, gas furnaces and other HVAC components as are well known in the art.

Electrical storage units store electricity for later use. Embodiments of electrical storage units include one or more rechargeable batteries or battery packs. The electrical capacity of electrical storage units including batteries may be varied by using different kinds of batteries, such as nickel-metal-hydride, lead-acid, and lithium-ion batteries. An electrical storage unit may be used to store power and to supplement electrical loads such as loads created by HVAC units. By electrically connecting an HVAC unit to an electrical storage unit, such as a battery, the HVAC unit may decrease its load on the electrical grid by selectively drawing supplemental power from the electrical storage unit. Moreover, if appropriately sized, the HVAC unit may draw its entire operating load from an electrical storage unit for a period of time, which may vary based on the charge capacity of the electrical storage unit and the size of the HVAC unit. Additionally, an electrical storage unit may be used to store energy from an electric grid during relatively less expensive times (e.g. off-peak hours) and that same energy may be used to supplement electrical devices, such as HVAC units, during relatively more expensive times (e.g. peak hours). Accordingly, integrating HVAC units with local electrical storage units such that operation of the HVAC unit may be partially or totally decoupled from the electric grid may increase the reliability and cost-effectiveness of the HVAC unit.

In another embodiment, the electrical storage units may be directly or indirectly charged by renewable energy sources. For example, a photovoltaic energy system may be used to charge the electrical storage unit. Alternatively, a wind turbine may be used to charge the energy storage unit.

Control of residential, commercial and other types of HVAC units is typically local i.e. accomplished by a resident of a home, a tenant of a building, etc., where the HVAC unit is located. Control is typically accomplished by a variety of different types of local HVAC controllers, such as mechanical and electrical thermostats. A thermostat may control an HVAC unit by measuring the ambient temperature within a residential home, and sending electrical signals to an HVAC unit to turn on or off based on the ambient conditions and the settings of the thermostat. For example, a thermostat may be set to maintain the temperature of a residence at about 72 degrees Fahrenheit. Accordingly, when the temperature climbs above 72 degrees Fahrenheit, the thermostat sends an appropriate electrical signal to the HVAC unit to commence cooling operations. The same process may be used where the temperature falls below a threshold and the thermostat sends an appropriate electrical signal to the HVAC unit to commence heating operations. Often, such local HVAC control modules include hysteresis properties to avoid constant cycling of the HVAC units. Local HVAC controllers may also have advanced functions such as multi-stage control of HVAC units (e.g. high and low furnace output), fan speed control, zone control, advanced scheduling, web-connected interfaces (e.g. TCP/IP compatibility), wireless control, and others.

Because consumers may have similar overall habits and schedules, many consumers may selectively activate and deactivate their HVAC units in large collective numbers during short time periods. For example, as residents of a neighborhood all arrive home in the evening at roughly the same time, they may all activate their HVAC units at roughly the same time. Likewise, when many businesses plan to open at the same time, they may likewise activate their HVAC units at or around the same time to make ready their commercial spaces for customers. This behavior creates large transient load spikes on the electrical grid because HVAC units draw a large amount of power. Additionally, the start-up of many HVAC components uses significantly more power than steady state running of the components, which compounds the problem for the utility power provider.

Accordingly, embodiments of the invention, which may include HVAC grid controllers, local HVAC controllers and local electrical storage units, provide utility power providers with more control over grid-connected HVAC units so as to increase the reliability and efficiency of power generation to the grid, while at the same time allowing consumers to benefit from more reliable and cost effective HVAC operation.

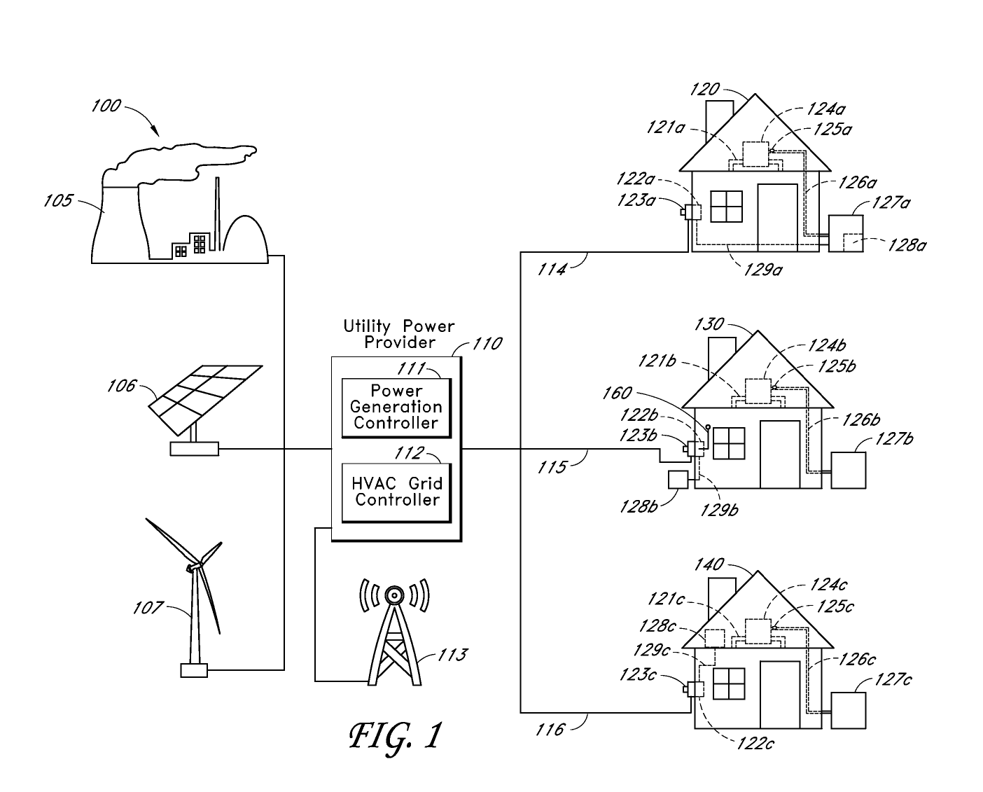

FIG. 1 is a schematic block diagram illustrating an embodiment of an electronic grid 100 with utility control of remote HVAC units. Utility power provider 110 includes power generation controller 111 and HVAC grid controller 112. Power generation controller 111 communicates with power generation units 105-107 to, for example, increase or decrease their rate of electrical generation or otherwise manage the power generation activities of these units. Power generation units, such as nuclear power generator 105, solar power generator 106 and wind turbine generator 107 are exemplary only, and embodiments may include other types of power generation devices. Utility power provider 110 may derive its electrical generation capacity from many different technologies both alone and in combination, including: coal-burning generators, hydroelectric generators, natural gas generators, and others as are known in the art.

The HVAC grid controller may be configured to send control signals to local HVAC controllers that are located within homes. The local HVAC controller may be instructed by the control signals to turn on or off the local HVAC systems, to cause local HVAC components to draw power from local electrical storage units; or to cause local electrical storage units to store excess power from the electric grid. For example, the HVAC grid controller 112 may be operated manually by utility power provider personnel, or programmed with logic that, for example, sends out appropriate signals when certain thresholds have been exceeded (e.g. grid load).

The HVAC grid controller 112 is electrically connected to residential enclosures 120, 130 and 140 via electric grid connections 114, 115 and 116. The electric grid connections 114, 115 and 116 may be, for example, electric power lines that carry electric power, electric signals or both simultaneously. The electric grid connections 114, 115 and 116 may alternatively be a plurality of individual connections such as a power line connection and a separate data line connection. The electric grid connections 114, 115 and 116 have the primary purpose of bringing power and electrical control signals to the residences 120, 130 and 140 from the utility provider 110 as well as receiving power usage data and other parameters from the residences. That is, in some embodiments the electric grid connections 114-116 allows for two way communications between the utility power provider 110 and the residences 120, 130 and 140. Note that the electrical connections between utility power provider 110 and the residential enclosures 120, 130 and 140 are greatly simplified for the purposes of this figure. Intermediate connections such as, for example, power substations, and intermediate equipment such as, for example, transformers and communication equipment are not shown and are beyond the scope of this figure, but are well known in the art.

In addition, the HVAC grid controller 112 is also connected to the residential enclosure 130 via a wireless control signals, which is transmitted from a transmitter 113 attached to the HVAC grid controller. An antenna 160 at the residential enclosure 130 may receive the wireless control signals transmitted by the transmitter 113. The wireless control signals may be, for example, data signals transmitted along CDMA, GSM, CDPD or other well-known wireless data transmission systems as appropriate.

The electric grid connections 114, 115 and 116 are electrically connected with electric grid interfaces 123a 123b and 123c respectively. The electric grid interfaces 123a, 123b and 123c may be, for example, electric meters installed at the residential enclosures 120, 130 and 140 by the utility power provider 110. The electric grid interfaces 123a, 123b and 123c may include sensors, processors and software capable of measuring the historical and instant electric usage of the residential enclosures 120, 130 and 140, respectively, as well as the current electric load, time of use, and other data. The electric grid interfaces 123a, 123b and 123c may be capable of one-way or two-way communication with, for example, the HVAC grid controller 112 of the utility power provider 110 via the electric grid connections 114, 115 and 116, respectively.

In the residential enclosure 120, the electric grid interface 123a is electrically connected to a local HVAC controller 122a. The electrical connection may be by methods well known in the art, such as single or multi-conductor electrical wires or wire looms. In some embodiments, the connection may include wired and wireless connections. The electrical connection between the electric grid interface 123a and the local HVAC controller 122a may provide operating power to the local HVAC controller 122 as well as HVAC control signals from the HVAC grid controller 112.

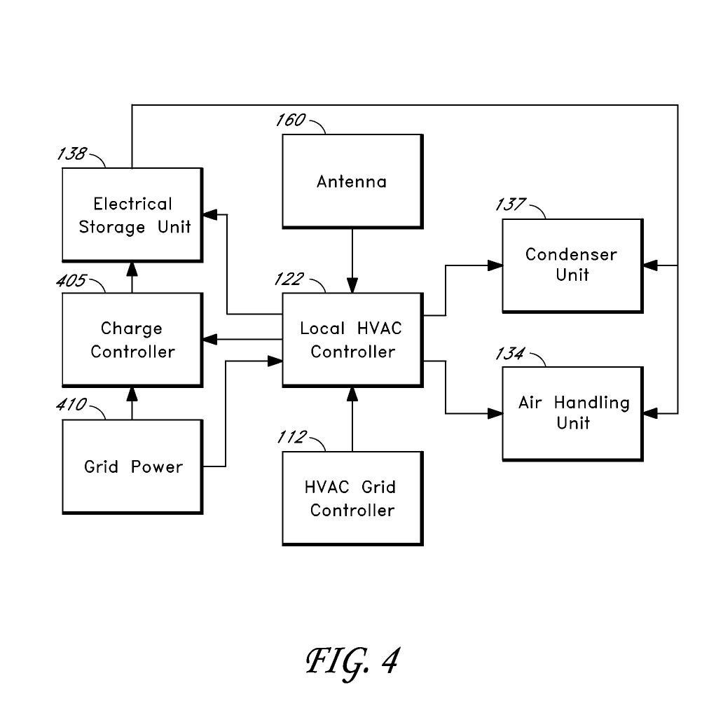

Local HVAC controller 122a controls the operation of components of a local HVAC condenser unit 127a and an air handling unit 124a via appropriate electrical connections (not shown), which may be wired or wireless. The local HVAC controller 122a may include hardware and software such that it is manually operable by a local user to control the local HVAC components, programmable to do the same or so that it may receive and act upon control signals received from the HVAC grid controller 112 as well as other connections such as a web connection. The local HVAC controller 122a also includes an electrical connection 129a with a local electrical storage unit 128a, which is integral with the condenser unit 127a in the embodiment of residential enclosure 120. The electrical connection 129a allows the local HVAC controller 122a to sense the stored capacity of the electrical storage unit 128a as well as to provide signals to the electrical storage unit 128a to flow power to the HVAC condenser unit 127a and air handling unit 124a, or to store grid power. Note that electrical connections between the electrical storage unit 128a and the HVAC condenser unit 127a and air handling unit 124a are not shown. The local HVAC controller 122a is described in more detail with respect to FIG. 4, below.

Residential enclosure 120 includes a complete HVAC system including the condenser unit 127a, piping 126a, a refrigerant control valve 125a, the air handling unit 124a and ducting 121a. Other HVAC components, such as a furnace, dehumidifier, etc. are not beyond the scope of this disclosure, but are omitted from FIG. 1 for simplicity. The condenser unit 127a compresses refrigerant and liquefies it by exchanging heat with the ambient environment as is described above. The liquefied refrigerant then flows through the piping 126a to the refrigerant control valve 125a and then into air handling unit 124a.

The electrical storage units 128a, 128b and 128c may be, for example, a battery, or a plurality of batteries electrically connected to each other, e.g. a battery pack. If multiple batteries are used, they may be connected in series or in parallel to produce resultant voltages different from the voltage of the individual battery units. Embodiments of electrical storage units may be, for example, nickel-metal-hydride, lithium-ion, lead-acid, or other battery types as are well known in the art. For example, the electrical storage unit 128a may include one or more lead-acid batteries, such as conventional automobile batteries. In the embodiment of residence 120, the electrical storage unit 128a is integral with the condenser unit 127a i.e. it is collocated with the condenser unit or installed within an enclosure with the condenser unit. As described above, the inclusion of the electrical storage unit 128a allows for grid electricity to be stored local to the HVAC system for later use. This allows, for example, the utility power provider 110 to send a control signal to the local HVAC unit to draw power from the electrical storage unit in addition to or instead of grid power. Likewise, a user may choose to store electricity to electrical storage unit 128a during off-peak hours, which then may be used to supplement power received from utility power provider during peak hours so as to reduce total electric costs. Finally, the utility power provider 110 may use the electric storage unit 128a to store excess generation capacity during off-peak hours when generation exceeds load, rather than slowing down generation if doing so would lower generating efficiency.

The residential enclosure 130 is similar to the residential enclosure 120 and 140; however, in this embodiment the local HVAC controller 122b includes an antenna 160 that is capable of receiving wireless control signals sent from the utility power provider's transmitter 113. Thus, in this embodiment, the control signals from HVAC grid controller 112 may be wirelessly received rather than received via physical electrical connection as is the case with the residential enclosures 120 and 140. In addition, the residential enclosure 130 has the electrical storage unit 128b installed external to the enclosure, but separate from the condenser unit 127b in contrast to the residential enclosure 120. The local HVAC controller 122b is electrically connected to electrical storage unit 128b via electrical connection 129b.

The residential enclosure 140 is similar to the residential enclosures 130 and 140. However, the electrical storage unit 128c is shown installed in the attic area of the residential enclosure 140. Installing electrical storage unit 128c in the attic may protect it from ambient conditions such as rain, sunlight and other potentially adverse conditions. Otherwise, the like-numbered features of residential enclosure 140 are the same and perform the same functions as that of the residential enclosures 120 and 130.

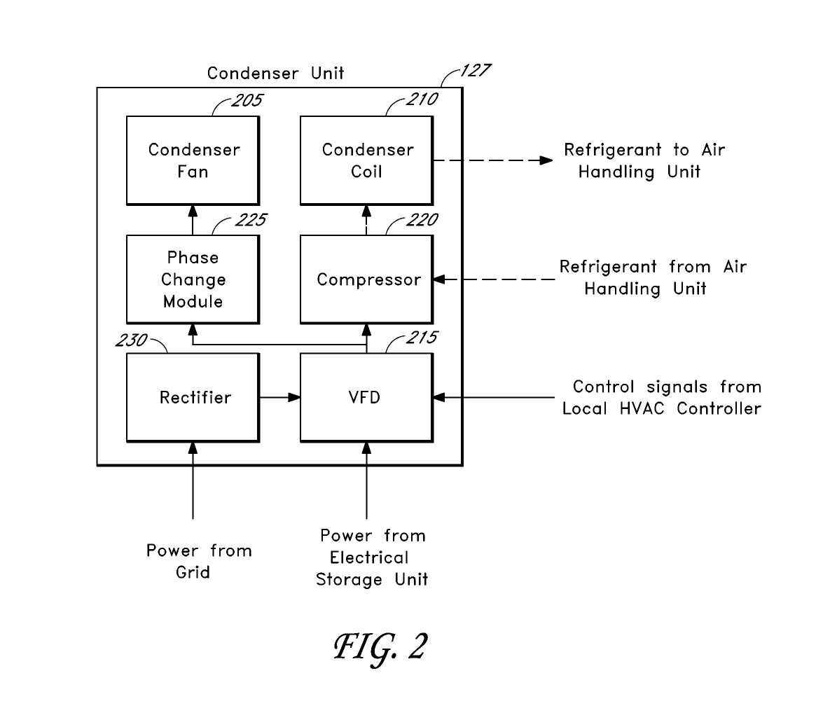

FIG. 2 is a schematic block diagram illustrating an embodiment of a condenser unit, such as condenser unit 127 of FIG. 1. The condenser unit 127 includes a compressor 220, which receives gaseous refrigerant from an air handling unit (not shown). Note: refrigerant flow is shown in broken lines. The compressor 220 compresses the gaseous refrigerant to high pressure, which also increases its temperature, and then the refrigerant flows to a condenser coil 210. The condenser coil 210 physically rejects heat from the HVAC system by cooling the hot, gaseous refrigerant from the compressor 220. In the process of cooling the refrigerant, it condenses into a liquid. Typically the condenser coil itself will be cooled by ambient air, forced air, or with another coolant such as water. In this embodiment, a condenser fan 205 blows air over and through the condenser coil 210 to increase the heat transfer process. Finally, the refrigerant flows from the condenser coil 210 back to the air handling unit (not shown).

In the embodiment of FIG. 2, the compressor 220 and the condenser fan 205 are controlled by a variable frequency drive (VFD) 215. The variable frequency drive 215 may increase the efficiency of the HVAC components, such as the compressor motor 220 by controlling the characteristics (e.g. frequency) of the power provided to the motor. Note that a VFD is not necessary and that the compressor 220 and the condenser fan 205 may be controlled by standard electrical connections and circuitry as are well known in the art. The VFD 215 outputs a three-phase AC signal to the compressor motor 220 to control its speed. The VFD 215 is also electrically connected to a phase change module 225, which changes the three phase AC power output of the VFD 215 to single-phase AC power more suitable for the condenser fan 205.

In other embodiments, the condenser fan 205 may be a three-phase AC motor and the phase change module would be unnecessary. The VFD 215 may receive DC power from a connected electrical storage unit as well as rectified DC power from the grid by way of a rectifier 230. The VFD 215 also receives control signals from the local HVAC controller to, for example, turn on or off the components of the condenser unit 127 or to speed up or slow down the same. In some embodiments, the utility power provider may send a control signal to cycle off HVAC components in a certain area, which would be received by the local HVAC controller, which in-turn would send appropriate control signals to HVAC components such as the VFD 215 of the condenser unit 127 to turn off. In other embodiments with no VFD, power from an electrical storage unit (not shown) may be inverted (i.e. changed from DC to AC) before being provided to an appropriate control circuit, or even directly to the compressor motor and condenser fan. In embodiments with no VFD, control signals from a local HVAC controller may be received by appropriate control circuitry to activate or deactivate the HVAC components of the condenser unit 127.

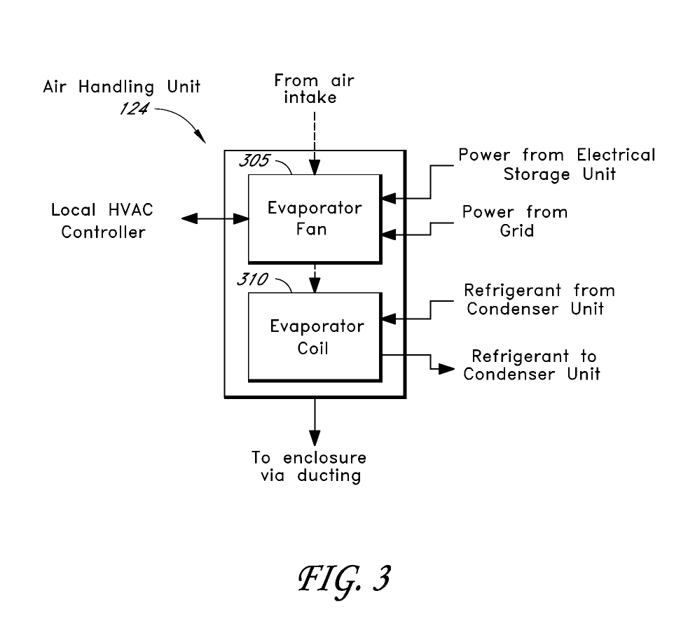

FIG. 3 is a schematic block diagram illustrating an embodiment of an air handling unit 124, such as air handling unit 124 of FIG. 1. The air handling unit 124 includes an evaporator fan 305, an evaporator coil 310 and ducting (not shown). Air flow is shown in broken lines. The evaporator coil 310 receives liquid refrigerant from the condenser unit and evaporates it in a coil, which extracts heat from the environment around the coil. Evaporated refrigerant then flows back to the condenser unit to restart the cycle. The evaporator fan 305 receives air from, for example, a filtered intake vent and forces the air through the evaporator coil where heat is extracted from the air. After the air flows through the evaporator coil 310 and is cooled, it is forced through ducting and into an enclosure, such as residential enclosures 120, 130 and 140 of FIG. 1.

The evaporator fan 305 receives control signals from the local HVAC controller to, for example, turn on or off, or speed up or slow down. The evaporator fan 305 may receive power from an electrical storage unit (not shown) or power from the electric grid (not shown) or a combination of both. Note that a VFD may be used to control the speed of the evaporator fan 305, such as was described with reference to the condenser fan 205 of FIG. 2. Alternatively, the evaporator fan 305 may have appropriate circuitry to receive control signals and operate accordingly. If receiving power from the electrical storage unit, an inverter (not shown) may be required to adapt the DC current to AC current suitable for the evaporator fan 305. Alternatively, if the evaporator fan 305 is a DC-type fan, the AC grid power would need to be rectified by a rectifier (not shown) before operating the evaporator fan 305.

FIG. 4 is a schematic block diagram illustrating an embodiment of a local HVAC controller 122, such as local HVAC controller 122 of FIG. 1. The local HVAC controller 122 may receive control signals from an HVAC grid controller 112 via a physical connection, such as the electric grid connection 115 on FIG. 1, or via wireless connection, such as from the wireless transmitter 113 of FIG. 1. When receiving wireless signals, the local HVAC controller 122 may include an antenna 160 or other means of receiving wireless electromagnetic signals as are known in the art. The local HVAC controller 122 is electrically connected to a condenser unit 137 and an air handling unit 134 and sends appropriate control signals to each to control, for example, the state (e.g. on or off) or speed of their respective HVAC components. In this embodiment, the local HVAC controller 122 is also electrically connected to a charge controller 405 so that it may control when an electrical storage unit 138 is charged with grid power. The charge controller 405 receives AC power from the electric grid (not shown) and conditions it to DC power appropriate to charge the electrical storage unit 138. The local HVAC controller 122 may cause grid power to be stored in the electrical storage unit 138 by either a local user or the remote utility power provider. For example, a utility power provider may wish to shed excess power on the electric grid and accordingly may send an appropriate control signal to the local HVAC controller 122 to activate the charge controller 405 to store grid power to the electrical storage unit 138.

Alternatively, a user may wish to store electrical power from the electric grid during off-peak hours, when electricity is cheaper, and may program the local HVAC controller 122 to receive grid power and store it to the electrical storage unit 138 via the charge controller 405. For example, the user could program the local HVAC controller 122 to activate the charge controller 405 between 2 AM and 4 AM every night.

The local HVAC controller 122 can also cause stored electricity to flow to local HVAC components, such as the condenser unit 137 and the air handling unit 134, to either supplement grid power or to replace it all together (e.g. in times when grid power is unavailable). For example, the local HVAC controller 122 may divert power from the electrical storage unit 138 when the local user directs it or when it receives appropriate control signals from a utility power provider. As an additional example, the user may additionally program the local HVAC controller 122 to use stored capacity to run the local HVAC components everyday between 2 PM and 4 PM, thereby avoiding peak energy charges. Likewise, a utility power provider could send a signal to the local HVAC controller 122 from the HVAC grid controller 112 to accomplish the same.

The local HVAC controller functions may be performed by hardware and software such as a programmable thermostat, or may be controlled by a dedicated computer with appropriate software. In alternative embodiments, the aforementioned functions of the local HVAC controller 122 may be accomplished by an add-on module that works with an existing mechanical or electrical thermostat so that retrofitting existing installations is possible. The specific functions of the local HVAC controller 122 may be programmed locally, e.g. on a thermostat with a touch-screen graphical user interface, or remotely, e.g. on a web-based configuration page. The local HVAC controller 122 may also have a display unit configured to show operating parameters, such as, for example, current temperature, set temperature, current fan speed, set fan speed, exterior temperature, battery charge and other parameters as desired by the user. Additionally, the local HVAC controller 122 may include networking hardware and software necessary for creating a connection, either wired or wireless, to the Internet, and may receive data, commands and configuration data from that connection (e.g. a TCP/IP connection).

The local HVAC controller 112 may include any form of controller or processor and preferably includes a digital processor, such as a general-purpose microprocessor or a digital signal processor (DSP), for example. The local HVAC controller 112 may be readily programmable by software; hard-wired, such as an application specific integrated circuit (ASIC); or programmable under special circumstances, such as a programmable logic array (PLA) or field programmable gate array (FPGA), for example. Program memory for the local HVAC controller 112 may be integrated within the local HVAC controller 112, or may be an external memory (not shown), or both. The local HVAC controller 112 may execute one or more programs or modules to perform the aforesaid functions. The local HVAC controller 112 may contain or execute other programs, such as to send control commands, transfer data, to associate data from the various components together (preferably in a suitable data structure), to perform calculations using the data, to otherwise manipulate the data, and to present results to a user (e.g. through a graphical user interface) or another processor.

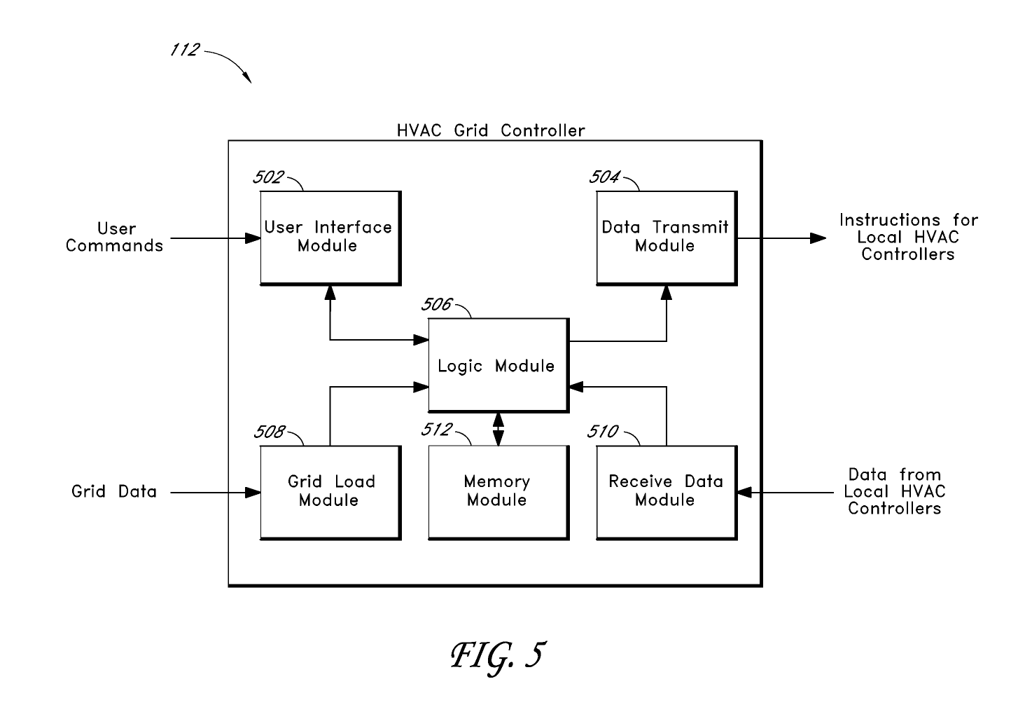

FIG. 5 is a schematic block diagram illustrating an embodiment of an HVAC grid controller 112, such as HVAC grid controller 112 of FIG. 1. The HVAC grid controller 112 includes a user interface module 502, a data transmit module 504, a logic module 506, a grid load module 508, a receive data module 510 and a memory module 512.

The user interface module 502 may include software and hardware necessary to provide an interface for users, such as a utility power provider. For example, the user interface module 502 may allow a user to send a control message to a local HVAC controller (not shown) or a group of local HVAC controllers to draw power from local electrical storage units as discussed above. Alternatively, the user interface module 502 may allow the user to program times when connected local HVAC controllers should draw power from their respective local electrical storage units. For example, the user interface module 502 may provide for a scheduling function where a user may select one or more time periods a day, such as a peak time, for the HVAC grid controller 112 to automatically send messages to local HVAC controllers to draw power from connected local electrical storage units.

The user interface module 502 may also receive data from the logic module 506. For example, the logic module 506 may receive grid data from the grid load module 508 and then send that data to the user interface module 502 for display to a user on, for example, a screen. Likewise, the user interface module 502 may receive data from local HVAC controllers by way of the receive data module 510 and logic module 506.

The grid load module 508 may include software and hardware necessary to receive grid data from the utility power provider (not shown). Grid data may be in the form of, for example, a current load on the grid as a percentage of total grid capacity (e.g. 82%), or may be raw grid data such as voltage of the grid (e.g. 119 volts). Furthermore, the grid data may include data regarding the current output of power generation, such as power generation units 105-107 of FIG. 1.

The data transmit module 504 may include software and hardware necessary to format commands to be sent to local HVAC controllers. The commands may be in the form of, for example, data packets operable in a TCP/IP network, or others as are well known in the art. The data transmit module 504 may select physical connections, such as the electric grid connections 114, 115 and 116 of FIG. 1, or may instead format data packets for transmission over wireless connections, e.g. to be transmitted from wireless transmitter 113 of FIG. 1.

The receive data module 510 may include software and hardware necessary to receive data from local HVAC controllers. For example, the received data may indicate a status of the local HVAC controller (e.g. on or off), a charge level of a local electrical storage unit (e.g. 80%), or other data as described above.

The memory module may provide temporary working memory (e.g. RAM) or permanent storage memory or both to the logic module. For example, an operating system may be stored in the memory module so that the logic module may create a program environment. Likewise, data received from the grid load module 508 and receive data module 510 may be stored in the memory module by the logic module 506 for later use. Configuration data, such as user commands input through the user interface module 502 may also be stored in the memory module 512 to instruct the logic module 506 on how to operate. The memory module 512 is electrically connected to the logic module 506.

The logic module 506 receives command data from the user interface module 502, grid data from the grid load module 508 and local HVAC controller data from the receive data module 510. The logic module may act on the received data as well as store the received data into memory module 512 for later use. The logic module may implement programs or algorithms stored in the memory module so as to create instructions for local HVAC controllers. Further, the logic module 506 may determine instructions and send those instructions to local HVAC controllers via data transmit module 504. For example, the logic module may receive an instruction from the user interface module indicating a need to reduce draw on the grid. Accordingly, the logic module 506 may instruct the data transmit module 504 to send instructions to connected local HVAC controllers to switch to drawing local stored energy. After some time, the logic module 506 may receive grid data from the grid load module 508 that indicates the grid load has dropped substantially. The logic module 506 may then instruct the data transmit module to send instructions to local HVAC controllers to switch to drawing grid power. The logic module may be hardware, software or a combination of the two.

The logic module 506 may include any form of controller or processor and preferably includes a digital processor, such as a general-purpose microprocessor or a digital signal processor (DSP), for example. The logic module 506 may be readily programmable by software; hard-wired, such as an application specific integrated circuit (ASIC); or programmable under special circumstances, such as a programmable logic array (PLA) or field programmable gate array (FPGA), for example. Program memory for logic module 506 may be integrated within the local HVAC controller 112, or may be an external memory (such as memory module 512), or both. The logic module 506 may execute one or more programs or modules to perform the aforesaid functions. The logic module 506 may contain or execute other programs, such as to send control commands, transfer data, to associate data from the various components together (preferably in a suitable data structure), to perform calculations using the data, to otherwise manipulate the data, and to present results to a user (e.g. through user interface module 502) or another processor.

The HVAC grid controller 112 may include additional modules or may include fewer modules that accomplish the same functions as those described above. For example, the HVAC grid controller 112 may be a computer system with a microprocessor, memory and software modules to perform the aforementioned functions and others.

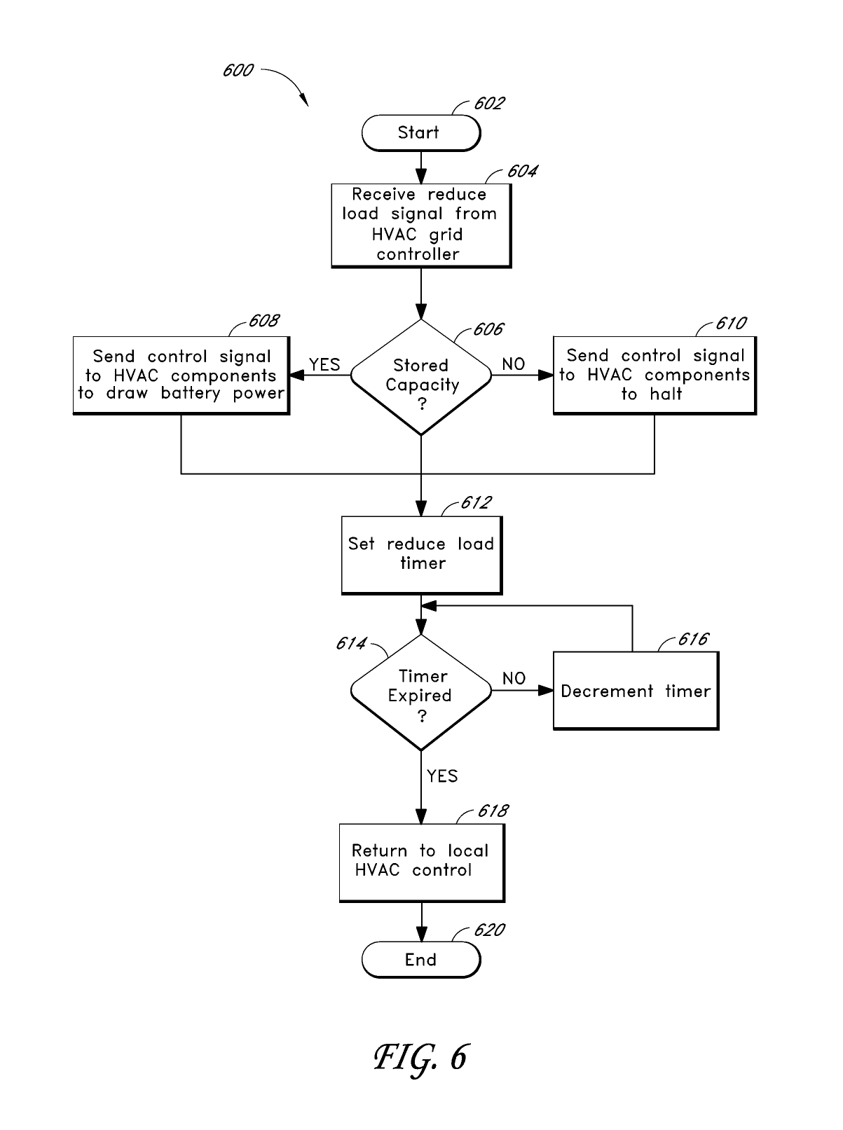

FIG. 6 is a process flow diagram showing an embodiment of a process for utility control of a remote HVAC system with an integral electrical storage unit using an HVAC grid controller and a local HVAC controller. The process 600 starts at state 602 and moves to state 604 where a local HVAC controller receives a signal from a remote HVAC grid controller to reduce load on the connected electric grid. Next, at state 606, the local HVAC controller determines whether there is any stored electric capacity in, for example, an electrical storage unit such as a battery. If at state 606 there is capacity, then the local HVAC controller sends a control signal to connected HVAC components to draw operating power from the connected electrical storage unit at state 608. Note that at this stage, the power drawn from the electrical storage unit may supplement grid power or may replace it completely. The command signal from the utility provider's HVAC grid controller may include an instruction to reduce load by a certain percentage or to reduce HVAC load all together. If at state 606 there is not stored capacity, then the local HVAC controller sends control signals to connected HVAC components to halt operation (i.e. turn off) at state 610. Next the process moves to state 612 where the local HVAC controller sets a reduced load timer. The amount of time the load is to be reduced may be a default amount (e.g. 10 minutes) or may be an amount set by the HVAC grid controller and sent as a parameter with the reduce load signal. At state 614, the local HVAC controller checks whether the reduce load timer has expired. If at state 614 the reduce load timer has not expired, then the local HVAC controller decrements the timer at state 616 and then returns to state 614. If at state 614 the timer has expired, then the process moves to state 618 where the local HVAC controller resumes local control of the HVAC components. The process then moves to and ends at state 620.

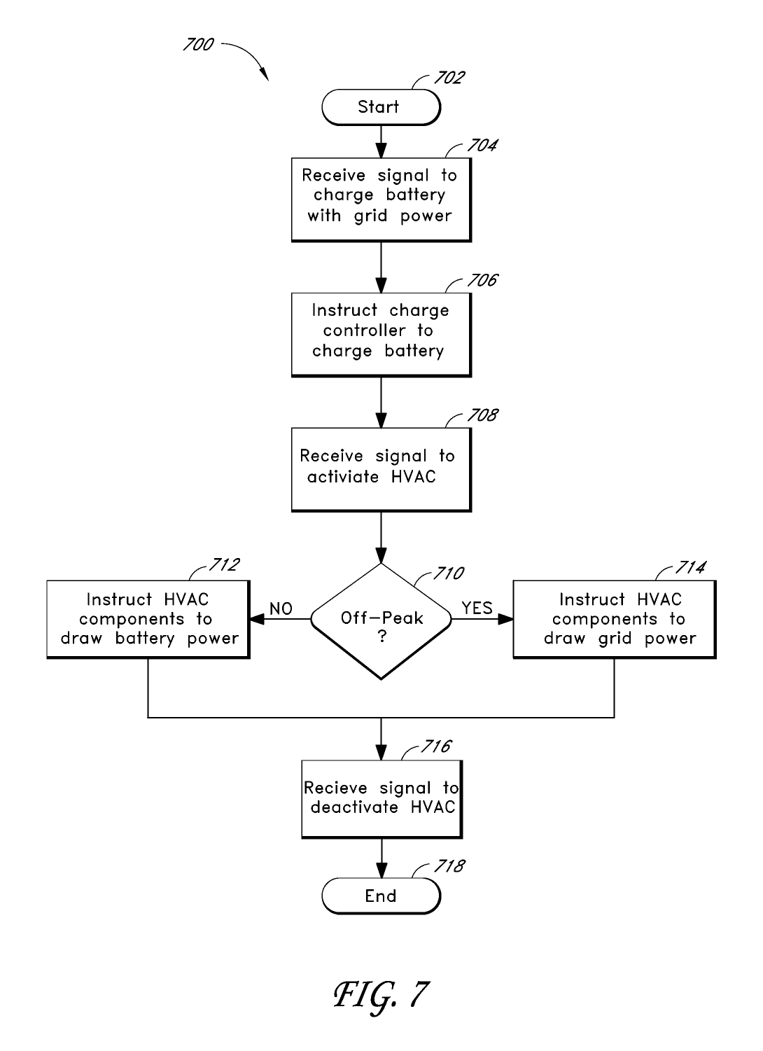

FIG. 7 is a process flow diagram showing an embodiment of a process for storing grid power during off-peak hours for use during peak hours using a local HVAC controller. The process 700 starts at state 702 and moves to state 704 where a local HVAC controller receives a signal to store grid power to an electrical storage unit, such as a battery, either from a user or from a remote HVAC grid controller. The user may wish to store grid power to the electrical storage unit during off-peak hours and to later use that stored capacity during peak hours to avoid peak electrical cost (i.e. to time-shift the cheaper electricity). Likewise, a utility power provider may wish to off-load excess electrical power during times of reduced loads in order to avoid altering its rate of power generation. In any event, the local HVAC controller receives the charge battery signal at state 704 and then instructs the charge controller to divert grid power to the battery at state 706. At state 708, the local HVAC controller receives a signal to activate the HVAC unit. This activation signal could be received manually by a user prompting the activation of the system, or based on a sensor signal passing a threshold (e.g. a temperature sensor exceeding a threshold temperature), or based on a pre-programmed run time or based on another triggering event. At state 710 the local HVAC controller determines whether the current time is an off-peak time (when grid power is less expensive) or a peak time (when grid power is more expensive). If at state 710 the local HVAC controller determines that it is not an off-peak time (i.e. it is a peak time), the local HVAC controller instructs the connected HVAC components to draw battery power to run the local HVAC components at state 712. Note that the battery power may either supplement or replace grid power totally depending on the capacity and state of the battery and other aspects of the system. If at state 710 the local HVAC controller determines that it is an off-peak time, the local HVAC controller instructs the connected HVAC components to draw grid power to run the local HVAC components at state 714. At state 716, the local HVAC controller receives a signal to deactivate the HVAC system. This could be in response to, for example, a user manually prompting deactivation of the system, a sensor signal passing a threshold (e.g. a temperature sensor falling below a threshold temperature), a programmed stop time, a signal from a remote HVAC grid controller to deactivate or based on another triggering event. The process then ends at state 718.

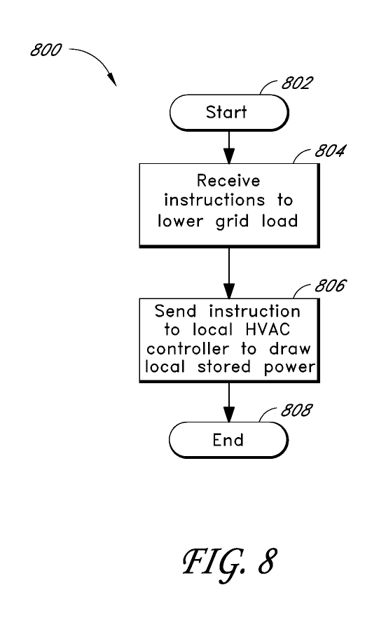

FIG. 8 is a process flow diagram showing an embodiment of a process for sending an instruction to a local HVAC controller using an HVAC grid controller. The process starts at state 802 and moves to state 804 where the HVAC grid controller receives an instruction indicating a need to lower grid load. This instruction could, for example, come from a user interface, such as that described with reference to FIG. 5, or be pre-programmed based on a time of day as also described with reference to FIG. 5, or be based on received grid data as also described with reference to FIG. 5. After receiving the instruction at state 804, the process moves to state 806 where the HVAC grid controller sends an instruction to one or more local HVAC grid controllers to draw power from local stored power, such as from a battery. After sending the instruction, the process moves to state 808 and ends.

The steps of a method described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of computer-readable storage medium known in the art. An exemplary storage medium may be coupled to the processor such the processor can read information from, and write information to, the storage medium. In the alternative, the storage medium may be integral to the processor. The processor and the storage medium may reside in an ASIC.

All of the processes described above may be embodied in, and fully automated via, software code modules executed by one or more general purpose or special purpose computers or processors. The code modules may be stored on any type of computer-readable medium or other computer storage device or collection of storage devices. Some or all of the methods may alternatively be embodied in specialized computer hardware.

Many of the methods and tasks described herein may be performed and fully automated by a computer system. The computer system may, in some cases, include multiple distinct computers or computing devices (e.g., physical servers, workstations, storage arrays, etc.) that communicate and interoperate over a network to perform the described functions. Each such computing device typically includes a processor (or multiple processors or circuitry or collection of circuits, e.g. a module) that executes program instructions or modules stored in a memory or other non-transitory computer-readable storage medium. The various functions disclosed herein may be embodied in such program instructions, although some or all of the disclosed functions may alternatively be implemented in application-specific circuitry (e.g., ASICs or FPGAs) of the computer system. Where the computer system includes multiple computing devices, these devices may, but need not, be co-located. The results of the disclosed methods and tasks may be persistently stored by transforming physical storage devices, such as solid state memory chips and/or magnetic disks, into a different state.

### Additional Embodiments of an HVAC System

The power supply system for an existing heating, ventilation, air conditioning, and refrigeration (HVAC/R) system may be configured, such that, rather than receiving power directly from an AC utility source, the HVAC/R system components receive power from another power supply, such as a VFD, which receives power from a DC bus. In the system the AC utility source provides power to the DC power bus of the HVAC/R system through, for example, a rectifier. The DC power bus is used to provide power to one or more power supplies which generate appropriate AC power for the HVAC/R system components, such as the compressor motor, condenser fan, and the evaporator fan or blower. An embodiment with an evaporator fan 432 is shown in FIG. 4.

In some embodiments, an HVAC/R system includes a compressor motor and a condenser fan which operate at the same time. In order to reduce the total number of power supplies, the compressor motor and the condenser fan are advantageously driven with the same power supply. In addition, at least because of power efficiency at startup of the compressor motor, a variable frequency drive power supply (VFD) is desirable. A VFD chops the DC voltage from the DC power bus into three outputs 120 degrees out of phase, which the motors driven see as AC.

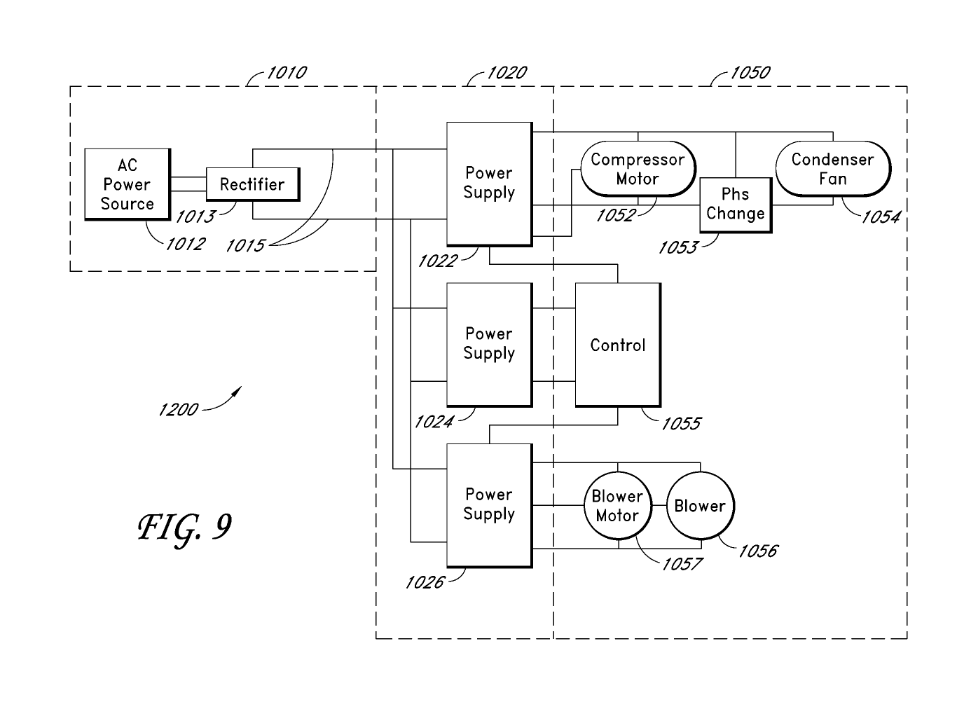

FIG. 9 is a diagram of one embodiment of an HVAC/R system. The HVAC/R system 1200 includes a power source section 1010, a power supply section 1020, and an HVAC/R component section 1050. The power source section 1010 includes power sources which provide power to the components of the HVAC/R system 1200. The power supply section 1020 includes power supplies which receive power from the power source section 1010 and condition the power for use by the HVAC/R components of the HVAC/R component section 1050. The HVAC/R components of the HVAC/R component section 1050 perform HVAC/R functions of the HVAC/R system.

In the embodiment of FIG. 9, the power source section 1010 includes a first power source 1012, a rectifier 1013, and a power bus 1015. In this embodiment, the first power source 1012 is an AC power source and provides power to the rectifier 1013, which provides substantially DC power to the power bus 1015. In alternative embodiments, the first power source 1012 may be a DC power source, which provides DC power to the power bus 1015. Accordingly, in such embodiments, the rectifier 1013 is omitted. In some embodiments, a second power source (not shown) is also configured to provide power to the power bus 1015.

Power source 1012 may be any type of power source. In the embodiment of FIG. 9, power source 1012 is an AC power source. Power source 1012, for example, may be an AC mains, such as that provided by the local power company. Power source 1012 may have, for example, one or three phases. In some embodiments, power source 1012 is a three-phase, about 240V, AC source. Other power sources include a solar or wind powered generator.

Rectifier 1013 is configured to receive AC power from the first power supply 1013, to rectify the power signal to a substantially DC level, and to provide the DC level to the power bus 1015 appropriate for the system.

The optional second power source may be a secondary or back-up power source, for example, a battery or a battery pack, configured to be charged. Other types of energy storage devices may also be used. The second power source is connected to the power bus 1015, and is configured to be charged by the power bus 1015 when the first power source 1012 is functioning and the second power source is not fully charged. The second power source is further configured to provide power to the power bus 1015 when the power from the rectifier 1013 or the first power source 1012 is insufficient for the load on the power bus 1015.

The power supply section 1020 includes power supplies which receive power from the power source section 1010 and condition the power for use by the HVAC/R components of the HVAC/R component section 1050. In the embodiment of FIG. 9, there are three power supplies 1022, 1024, and 1026. In other embodiments, fewer or more power supplies are used. Each of the power supplies of the power supply section 1020 are used to supply power to one or more of a plurality of components of the HVAC/R component section 1050. In the embodiment shown, each of the power supplies 1022, 1024, and 1026 are connected to the power bus 1015.

In this embodiment, power supply 1022 is configured to supply power to two motors: compressor motor 1052 and the motor of condenser fan 1054. Power supply 1024 is configured to supply power to control module 1055, and power supply 1026 is configured to supply power to the motor 1057 of evaporator blower 1056. Although shown separately, rectifier 1013 may be integrated with power supply 1022.

In one embodiment, power supply 1022 is a 10 hp variable frequency drive power supply (VFD). In some embodiments, the VFD comprises the power supply 1022 and the rectifier 1013. A VFD may be used because of increased power efficiency achieved through controlled startup of the compressor motor 1052. When a constant frequency and voltage power supply, such as an AC mains power supply, is used, inrush current to start a motor may be six to ten times the running current. Because of system inertia, the compressor motor is not powerful enough to instantaneously drive the load at full speed in response to the high frequency and high speed signal of the power supply signal needed at full-speed operation.

The result is that the motor goes through a start-up phase where the motor slowly and inefficiently transitions from a stopped state to full speed. During start up, some motors draw at least 300% of their rated current while producing less than 50% of their rated torque. As the load of the motor accelerates, the available torque drops and then rises to a peak while the current remains very high until the motor approaches full speed. The high current wastes power and degrades the motor. As a result, overall efficiency, effectiveness, and lifetime of the motor are reduced.

When a VFD is used to start a motor, a low frequency, low voltage power signal is initially applied to the motor. The frequency may be about 2 Hz or less. Starting at such a low frequency allows the load to be driven within the capability of the motor, and avoids the high inrush current that occurs at start up with the constant frequency and voltage power supply. The VFD is used to increase the frequency and voltage with a programmable time profile which keeps the acceleration of the load within the capability of the motor. As a result, the load is accelerated without drawing excessive current. This starting method allows a motor to develop about 150% of its rated torque while drawing only 50% of its rated current. As a result, the VFD allows for reduced motor starting current from either the AC power source 1012, reducing operational costs, placing less mechanical stress on the compressor motor 1052, and increasing service life. The VFD also allows for programmable control of acceleration and deceleration of the load.

The VFD of power supply 1022 is controlled by control module 1055, and produces a three-phase output, which powers the compressor motor 1052, a three-phase motor. The compressor motor 1052 has rotational symmetry of rotating magnetic fields such that an armature is magnetized and torque is developed. By controlling the voltage and frequency of the three-phase power signal, the speed of the motor is controlled whereby the proper amount of energy enters the motor windings so as to operate the motor efficiently while meeting the demand of the accelerating load. Electrical motive is generated by switching electronic components to derive a voltage waveform which, when averaged by the inductance of the motor, becomes the sinusoidal current waveform for the motor to operate with the desired speed and torque. The controlled startup of compressor motor 1052 described above allows for high power efficiency and long life of compressor motor 1052.

Use of a VFD to power the compressor motor 1052 allows for speed control, removing the limitation on the system to be either fully on or off. For example, an HVAC/R system with a VFD can operate the compressor at a speed corresponding to the cooling requirements of the environment having its temperature controlled. For example, if the controlled environment generates 500 watts of power, the compressor can be operated at a speed that corresponds to the heat generated by the 500 watts. This allows for improved power efficiency in the system because power inefficiencies experienced with repeatedly starting and stopping the compressor is avoided.

Furthermore, in some controlled environments, such as well insulated spaces, the heat generated is relatively constant. Accordingly, the energy to be removed is relatively constant. For such environments, the compressor motor may be designed for operation according to the load corresponding to the relatively constant energy to be removed. Such limited range of load allows for the compressor to be efficiently operated.

Another benefit to speed control is that the range of temperatures in controlled environment is dramatically reduced when compared to conventional HVAC/R systems in which the compressor is either fully on or off. In conventional HVAC/R systems, in order to prevent frequent state changes between off and on, the control system works with a hysteresis characteristic. In such systems, temperature excursions correspond to the hysteresis. For example, in some systems the hysteresis of the system is 3 degrees. If the temperature is set to −5 C, once the temperature of the environment is −5 C, the compressor is turned off. However, because of the 3 degrees of hysteresis, the compressor will not be turned on again until the temperature of the environment is −2 C. In contrast, in an HVAC/R system with a VFD controlling the compressor, the active control system incrementally increases and decreases the speed of the compressor to provide precise control of the temperature in the environment. As a result, there is no hysteresis, and, accordingly, significantly reduced trade-off between consistency of temperature and power consumption.

In the embodiment shown, the three-phase output of power supply 1022 powers both the condenser fan 1054 and the compressor motor 1052 and both are operated together. The result is beneficial system cost savings by eliminating a power supply dedicated to the condenser fan 1054. In addition, the system has speed control and the range of the speed control is unlimited for the one or more 3-phase motors and is limited at the low end of the range for the one or more 1-phase motors. While the discussion herein is generally directed to a system having a condenser fan 1054 and a compressor motor 1052, it is to be understood that the discussion applies to systems having one or more additional three-phase motors and/or one or more additional single-phase motors driven by power supply 1022.

Conventional electromechanical controls knowledge might suggest that when a VFD is used with a compressor motor, the single-phase motor of the condenser fan is discarded and replaced with a three-phase motor compatible with the variable speed three-phase output of the power supply. In the system described and shown herein, because the condenser fan 1054 does not need to have a three-phase motor, a less expensive single-phase motor is used for the condenser fan 1054, and the three-phase power from power supply 1022 is conditioned by phase change module 1053.

As shown in FIG. 9, phase change module 1053 is connected between the VFD power supply 1022 and condenser fan 1054. Single-phase motors such as condenser fan 1054 are not generally compatible with variable frequency and voltage operation. In single-phase motors, a “new” phase is generated to be used with the single phase of the input power signal to create rotating magnetism to the armature to generate torque. For example, if the single-phase motor is a shaded pole motor, a shading ring serves as an inductance capable of storing a magnetic field and generating the “new” phase. If the single-phase motor is a permanent split capacitor motor, a capacitor provides a phase lead of current to one terminal relative to another. The power efficiency of the shading ring and the capacitor, however, is frequency dependent, and therefore these elements are tuned to the running frequency of the motor according to its application. At non-specified frequencies, the behavior of the motor and that of the new phase generating elements are inefficient and the motor torque suffers. In addition, the power output signal of the VFD has large transient voltage spikes at high frequencies (e.g. 2-6 KHz). These transients can exceed the breakdown voltage of the new phase generating elements, and cause high current spikes which increase heat and reduce power efficiency of the motor and its components. Therefore, these motors are ineffective for use in a variable frequency drive scheme.

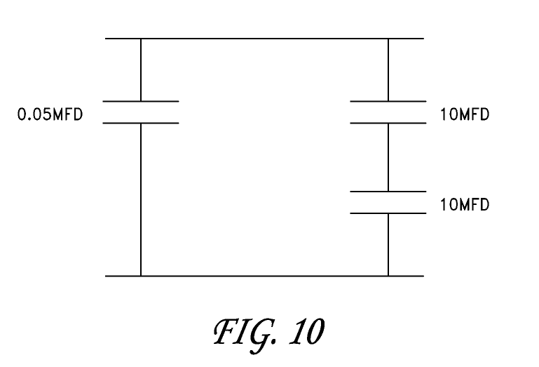

The preexisting single-phase motor of condenser fan 1054 may be modified to operate efficiently in the variable frequency drive scheme of FIG. 9. The single-phase motor is similar to a three-phase motor where the first two poles carry the single phase of the power input, and the third pole receives the new phase generated by the inductive and capacitive elements. In HVAC/R system 1200, the single-phase motor of condenser fan 1054 receives two of the three phases generated by the power supply 1022. In addition, the modified single-phase motor has its new phase generation elements replaced with elements which are compatible with the large transient voltage spikes of the VFD, such as those shown in FIG. 10. In one embodiment of phase change circuit 1053, the modification of the single-phase motor includes replacing the run capacitor with two capacitors of twice the capacitance, in series. These capacitors are shown as 10 MFD capacitors in FIG. 10. This increases the breakdown voltage while keeping the capacitance value, and therefore the tuning of the motor, unchanged. In addition, a capacitor with a ceramic composition and value in the range of 0.01 to 0.1 MFD placed in parallel with the two run capacitors, also shown in FIG. 10, provides lower impedance to the high frequency switching transients created by the VFD. For example, in a single-phase motor a main winding may be in parallel with a series connected 5 MFD run capacitor and auxiliary winding. The 5 MFD run capacitor may be replaced with two series connected 10 MFD capacitors in parallel with a 0.05 MFD capacitor, as shown in FIG. 10.

Power supply 1024 of power supply section 1020 is configured to supply power to control module 1055. The control module 1055 is the system control electronics, which provides control signals to other HVAC/R system components and power supplies. For example, the control module 1055 may control power supplies 1022 and 1026. In some embodiments, the control module 1055 outputs an AC control signal, which is used with a relay to turn on or off the power supplies 1022 and 1026. In some embodiments, control module 1055 is in communication with a user control panel, which the user activates, for example, to select a desired temperature. In some embodiments, the control module 1055 is in communication with a thermostat. In the HVAC/R system 1200, control module 1055 operates with a 24V single-phase AC power supply, provided by power supply 1024. In some embodiments, power supply 1024 comprises a DC/AC inverter which receives the DC signal from power bus 1015, and generates the 24V AC power supply for control module 1055.

In some embodiments, power supply 1024 comprises a switching type inverter which generates a pseudo-sine wave by chopping the DC input voltage into pulses. The pulses are used as square waves for a step-down transformer which is followed by a wave shaping circuit, which uses a filter network to integrate and shape the pulsating secondary voltage into the pseudo-sine wave.

Power supply 1026 is configured to supply power to the motor 1057 of blower 1056. In some embodiments, blower 1056 comprises a single-phase motor. In some embodiments, blower 1056 comprises a three-phase motor and power supply 1026 is configured to generate a three-phase power supply signal. For reasons similar to those described above with regard to power supply 1024 comprising a VFD to efficiently turn on compressor motor 1052, power supply 1026 may comprise a second VFD configured to efficiently turn on and turn off the motor of the blower 1056. In some embodiments, the second VFD is a 5 hp VFD. In some embodiments, blower 56 may be operated independently from the compressor motor 1052 and condenser fan 1054. For example, a user may desire to have the blower 1056 running and the compressor motor 1052 and condenser fan 1054 off. As a result, because VFD's are not generally suitable for abruptly changing loads, the blower 1056 receives power from the second VFD of power supply 1026.

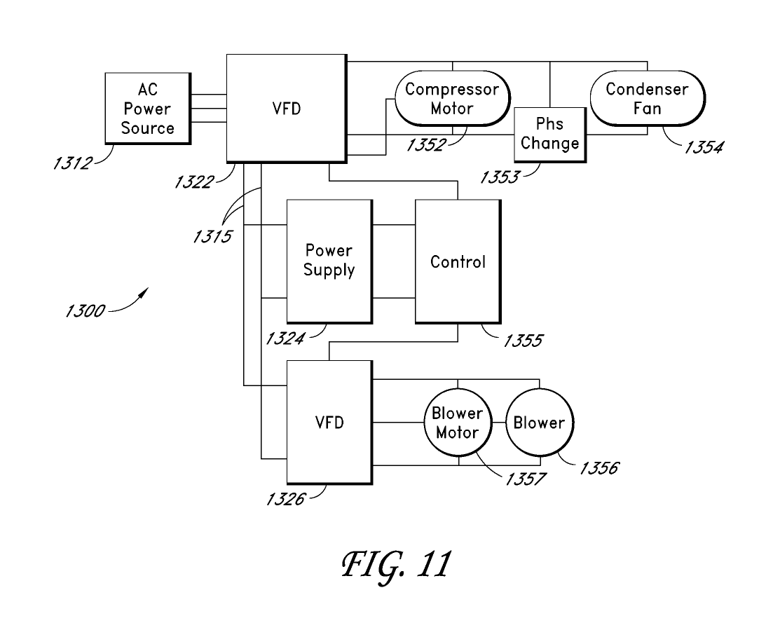

In some embodiments, HVAC/R system 1200 is implemented as shown in HVAC/R system 1300, shown in FIG. 11. In this embodiment, the rectifier 1013 of FIG. 9 is included in the VFD power supply 1322 of FIG. 11. An AC power source 1312, which may be similar to AC power source 1012 of FIG. 9, drives the VFD 1322, which generates a substantially DC voltage for its own operation and for driving power bus 1315. VFD 1322 may have similar functionality as power supply 1022 of FIG. 9. The other components shown in FIG. 11, compressor motor 1352, phase change circuit 1353, condenser fan 1354, power supply 1324, control module 1355, VFD power supply 1326, and a motor 1357 of a blower 1356, may each have similar functionality to the corresponding components shown in FIG. 9, compressor motor 1052, phase change circuit 1053, condenser fan 1054, power supply 1024, control module 1055, power supply 1026, and blower 1056, respectively.

In another embodiment an HVAC/R system using a variable frequency drive (VFD) power supply as described above incorporates a pulsed operation control valve to control refrigerant flow to the evaporator from the condenser. The VFD powered HVAC/R system yields varying compressor-speeds resulting in variable refrigerant flows to the condenser and to the evaporator. However, conventional expansion devices such as capillary tubes or expansion valves (AEV or TEV) cannot handle or take advantage of varying refrigerant flows and hunt or flood, thereby reducing evaporator efficiency and system performance. In order to achieve desired advantages of such variable refrigerant flows, according to this embodiment, a pulsing refrigerant control valve is used to produce a full range of evaporator superheat control at all refrigerant flows without starving or flooding the evaporator. Such refrigerant control is especially important at lower refrigerant flow rates resulting from variable compressor speeds. Conventional expansion devices are designed to operate at full flow and are inefficient at lower flows, and fluctuating flows, again, starving and/or flooding the evaporator. The pulsing valve may be a mechanical valve such as described in U.S. Pat. Nos. 5,675,982 and 6,843,064 or an electrically operated valve of the type described in U.S. Pat. No. 5,718,125, the descriptions of which are incorporated herein by reference in their entireties. Such valves operate to control refrigerant-flow to the evaporator throughout the variable refrigerant flow ranges from the compressor and condenser.

While the above detailed description has shown, described, and pointed out novel features as applied to various embodiments, it will be understood that various omissions, substitutions, and changes in the form and details of the devices and processes illustrated may be made by those skilled in the art without departing from the spirit of the invention. For example, inputs, outputs, and signals are given by example only. As will be recognized, the present invention may be embodied within a form that does not provide all of the features and benefits set forth herein, as some features may be used or practiced separately from others. Moreover, it is to be understood that the HVAC/R systems described herein may be configured as air conditioners, chillers, heat pumps and refrigeration systems, but are not limited thereto.

What is claimed is:

1. A control system for managing remote Heating, Ventilation and Air Conditioning (“HVAC”) systems that are part of a control grid, comprising:
a local HVAC controller electrically linked to a local HVAC system;
a HVAC grid controller operative to send the local HVAC controller a control signal to manage the operation of the HVAC system; and
a local electrical storage unit configured to provide power to the local HVAC system when instructed by either the local HVAC controller or the HVAC grid controller.

2. The control system of claim 1, wherein the electrical storage unit is one or more batteries.

3. The control system of claim 1, wherein the local HVAC controller comprises an electronic thermostat.

4. The control system of claim 1, wherein the HVAC unit comprises an air conditioner.

5. The control system of claim 1, wherein the HVAC grid controller is configured to instruct the local HVAC system to use power only from the electrical storage unit.

6. The control system of claim 1, wherein local HVAC controller is configured instruct the local HVAC system to use power from the electrical storage unit during predetermined times of the day.

7. The control system of claim 1, wherein local HVAC controller is configured instruct the local HVAC system to use power from the electrical storage unit when power charges rise above a predetermined threshold.

8. The control system of claim 1, further comprising a photovoltaic or wind turbine system configured to provide power to the local electrical storage unit.

9. A method of controlling a local Heating, Ventilation and Air Conditioning (“HVAC”) unit connected to a control grid, comprising:
receiving a control instruction from a HVAC grid controller configured to control power usage of a local HVAC system;
determining if the control instruction conflicts with any pre-stored instructions for the local HVAC system; and
changing power input from a main electrical source to a local energy storage based on the received data signal if the control instruction does not conflict with the pre-stored instructions.

10. The method of claim 9, further comprising determining at a local HVAC controller that the local storage unit does not have remaining electrical capacity and providing electrical power to the local HVAC unit from a main power source.

11. The method of claim 9, wherein receiving the control instruction comprises wirelessly receiving the control instruction.

12. The method of claim 9, wherein the HVAC grid controller is linked to a plurality of local HVAC systems.

13. The method of claim 9, wherein determining if the control instruction conflicts with any pre-stored instructions for the local HVAC system comprises comparing the control instruction with a set of instructions at a local HVAC controller.

14. A method of using a local Heating, Ventilation and Air Conditioning (“HVAC”) controller, comprising:
receiving a command at a local HVAC controller to store power from a main power source to a local electrical storage unit connected to a local HVAC system; and
sending a control signal to begin charging the local electrical storage unit with power from the main power source.

15. The method of claim 14, wherein the electrical storage unit is at least one battery.

16. The method of claim 14, wherein the command is received in response to a threshold cost of purchasing power being reached.

17. The method of claim 14, wherein the command is received from a control grid configured to control a plurality of HVAC systems.

18. The method of claim 14, further comprising determining whether the cost of purchasing electricity from the main power source is above a threshold, and if it is above a threshold, delaying the charging of the local electrical storage unit.

19. The method of claim 14, further comprising:
setting a timer at a local HVAC controller connected to the local HVAC system; and
upon expiration of the timer, causing a local HVAC unit to stop charging the local electrical storage unit.

20. The method of claim 14, wherein the command is received through an Internet connection.
